(19) United States
(12) Patent Application Publication
(10) Pub. No.: US 2026/0336991 A1
(43) Pub. Date: Oct. 29, 2026

(54) FOUR-POST DOUBLE-LAYER PARKING LIFT

(71) Applicant: Jihao ZOU, GUANGZHOU (CN)

(72) Inventor: Jihao ZOU, Guangzhou (CN)

(21) Appl. No.: 19/650,327

(22) Filed: Apr. 16, 2026

(30) Foreign Application Priority Data
Apr. 28, 2025 (CN) 2025105444878

(51) Int. Cl. B66F 7/28; B66F 7/20

(52) U.S. Cl. CPC B66F 7/28; B66F 7/20

(57) ABSTRACT

A four-post double-layer parking lift includes a four-post bracket, an upper-layer car-carrying platform, a lower-layer car-carrying platform, and a hydraulic driving device. The four-post bracket is provided with four single columns, each provided with an outer sliding slot and an inner sliding slot that are parallel to each other. The lower-layer car-carrying platform comprises lower-layer crossbeams and a lower-layer car-supporting plate. The lower-layer crossbeams are slidably connected to the inner sliding slots and driven by the hydraulic driving device. The upper-layer car-carrying platform comprises upper-layer crossbeams and an upper-layer car-supporting plate. The upper-layer crossbeams are slidably connected to the outer sliding slots. The lower-layer crossbeam is equipped with a ramp assembly having an accommodating groove. The upper-layer crossbeam is embedded in the accommodating groove. The upper-layer car-supporting plate wraps the lower-layer car-supporting plate. When the lower-layer crossbeam moves, the ramp assembly moves synchronously to drive the upper-layer crossbeam.

### TECHNICAL FIELD

The invention relates to the technical field of lifts, particularly to a four-post double-layer parking lift.

### BACKGROUND

Double-layer lifts are widely used in the fields of automobile maintenance, inspection, and logistics warehousing. Their core function is to achieve multi-layer parking of cars through layered lifting. Existing double-layer lifts usually configure an independent ramp for each layer of car-supporting plate. Although this facilitates the drive-on and drive-off operations of cars, the cost is increased. Meanwhile, the vertical structure formed by stacking multi-layer ramps produces a large step drop, which may cause damage to a car chassis when the car drives in due to the step drop. Furthermore, in order to achieve double-layer lifting, the prior art generally adopts a double-column frame, that is, each column frame specifically serves a single layer of car-supporting plate, and it is also necessary to configure two sets of hydraulic driving systems to respectively drive the upper-layer car-supporting plate and the lower-layer car-supporting plate. Although the independence of movement for each layer of car-supporting plate is ensured, it leads to a large space occupation of the overall equipment and a more complex mechanical structure. For this reason, it is necessary to make improvements to the prior art to solve the above problems.

### SUMMARY

An object of the invention is to provide a four-post double-layer parking lift, aiming at solving the problems in the prior art where the upper-layer car-supporting plate and the lower-layer car-supporting plate of a double-layer lift respectively adopt independent ramps, column frames, and hydraulic driving systems, resulting in increased cost and complex structure.

In order to achieve the above object, the invention provides a four-post double-layer parking lift, comprising a four-post bracket, an upper-layer car-carrying platform, a lower-layer car-carrying platform, and a hydraulic driving device, the four-post bracket being provided with four single columns, each single column being provided with an outer sliding slot and an inner sliding slot that are parallel to each other, the lower-layer car-carrying platform comprising two front and rear lower-layer crossbeams and a lower-layer car-supporting plate supported by the two lower-layer crossbeams, two ends of each lower-layer crossbeam being slidably connected to the inner sliding slots and driven by the hydraulic driving device to lift and lower, the upper-layer car-carrying platform comprising two front and rear upper-layer crossbeams and an upper-layer car-supporting plate supported by the two upper-layer crossbeams, and two ends of each upper-layer crossbeam being slidably connected to the outer sliding slots;

a ramp assembly is mounted on a front side of the lower-layer crossbeam, the ramp assembly is provided with an accommodating groove, the upper-layer crossbeam is configured to be embedded into the accommodating groove from top to bottom, when the upper-layer crossbeam is embedded in the accommodating groove, the upper-layer car-supporting plate wraps the lower-layer car-supporting plate from top to bottom, and when the lower-layer crossbeam lifts or lowers, the ramp assembly lifts or lowers synchronously and causes the upper-layer crossbeam to follow the lifting or lowering by means of the ramp assembly;

an upper-layer safety lock mechanism for locking the upper-layer crossbeam at a top of the single column is disposed between the single column and the upper-layer crossbeam, and a lower-layer safety lock mechanism for locking the lower-layer crossbeam at a middle of the single column is disposed between the single column and the lower-layer crossbeam.

Further, the ramp assembly comprises a first ramp, a sliding pin, and a cover plate, the accommodating groove is disposed in the first ramp, a side surface of the first ramp is provided with a sliding through slot, a side surface of the cover plate is provided with a through hole, the sliding pin passes through the sliding through slot and the through hole, and a placement mode of the cover plate is changed by means of sliding the sliding pin within the sliding through slot so as to enable the cover plate to be in a first state, a second state, and a third state;

when the cover plate is in the first state, the cover plate leaves the accommodating groove so that an upper part of the accommodating groove is open, and the upper-layer crossbeam is configured to be embedded into the accommodating groove from top to bottom;

when the cover plate is in the second state, the cover plate is configured to cover the accommodating groove;

when the cover plate is in the third state, the cover plate is configured to be in a standing state.

Further, the first ramp comprises a ramp inclined plate connected to a front of the accommodating groove, a mounting flat plate connected to a rear of the accommodating groove, and ramp side plates connected to two sides of the ramp inclined plate, the sliding through slot is disposed in each ramp side plate, the mounting flat plate is used for connection with the lower-layer crossbeam, the sliding through slot comprises a first sliding segment, a second sliding segment, a third sliding segment, and a fourth sliding segment which are communicated in sequence, a front end of the first sliding segment is a first positioning point, a junction between the second sliding segment and the third sliding segment is a second positioning point, a rear end of the fourth sliding segment is a third positioning point, and a connecting line between the first positioning point and the second positioning point is parallel to the ramp inclined plate; the cover plate comprises a shielding plate and connection side plates connected to two sides of the shielding plate, and the through hole is disposed in each connection side plate;

in the first state, the sliding pin slides to the first positioning point, a bottom surface of the shielding plate fits with a top surface of the ramp inclined plate, and a rear edge of the shielding plate does not extend above the accommodating groove;

in the second state, the sliding pin slides to the second positioning point, a front edge of the shielding plate is overlapped on the ramp inclined plate, and the rear edge of the shielding plate is overlapped on the mounting flat plate;

in the third state, the sliding pin slides to the third positioning point, the shielding plate is placed in a posture with the front edge at a lower position and the rear edge at an upper position, the front edge of the shielding plate is supported by the ramp inclined plate, and an overall center of gravity of the shielding plate is further forward than the front edge.

Further, a Cartesian coordinate system is established with the first positioning point as a coordinate origin, a horizontal plane is in an X direction, and a vertical plane is in a Y direction, a direction of the first sliding segment extends along an inclined direction between a positive X-axis direction and a positive Y-axis direction, a direction of the second sliding segment extends along an inclined direction between a negative Y-axis direction and the positive X-axis direction, a direction of the third sliding segment extends along the inclined direction between the positive X-axis direction and the positive Y-axis direction, and a direction of the fourth sliding segment extends upwardly along the positive Y-axis direction.

Further, the connection side plate is provided with a handle.

Further, the ramp assembly further comprises a second ramp, the second ramp is hingedly connected to the first ramp through a connecting shaft, and the second ramp is configured to rotate around an axis of the connecting shaft so that a top surface of the second ramp fits with a top surface of the first ramp.

Further, the upper-layer safety lock mechanism comprises a primary safety lock component and a secondary safety lock component, the primary safety lock component is disposed on the upper-layer crossbeam, the secondary safety lock component is disposed on the single column, the single column is provided with a primary lock hole, the upper-layer crossbeam is provided with a primary lock seat, and the primary lock seat is provided with a secondary lock ear;

when the primary safety lock component is inserted into the primary lock hole and the secondary safety lock component hooks the secondary lock ear, the upper-layer car-carrying platform is in a locked state;

when the primary safety lock component is disengaged from the primary lock hole and the secondary safety lock component is disengaged from the secondary lock ear, the upper-layer car-carrying platform is in an unlocked state.

Further, the primary safety lock component comprises a primary cylinder, a primary connecting block, and a primary stop block, a fixed end of the primary cylinder is hingedly connected to the primary lock seat, a portion of the primary stop block is hingedly connected to the primary lock seat, another portion is hingedly connected to a telescopic end of the primary cylinder through the primary connecting block, and the primary stop block is configured to be driven by the primary cylinder to be inserted into or disengaged from the primary lock hole;

the secondary safety lock component comprises a secondary cylinder, a secondary connecting block, a secondary latch pin, and a secondary stop block, the single column is provided with a secondary lock seat, a fixed end of the secondary cylinder is hingedly connected to the secondary lock seat, a portion of the secondary stop block is hingedly connected to the secondary lock seat through the secondary latch pin, another portion is hingedly connected to a telescopic end of the secondary cylinder through the secondary connecting block, and the secondary stop block is configured to be driven by the secondary cylinder to hook or be disengaged from the secondary lock ear.

Further, the upper-layer crossbeam is provided with a transition plate, and when the upper-layer crossbeam is embedded in the accommodating groove, the transition plate is configured to cover the accommodating groove.

Further, the four-post double-layer parking lift is configured to park three cars;

before parking a first car, the upper-layer crossbeam and the lower-layer crossbeam are at a lowest position, at this time the upper-layer crossbeam is located in the accommodating groove, the cover plate is in the first state, then the first car drives into the upper-layer car-carrying platform, the cover plate changes to the third state, the hydraulic driving device drives the lower-layer crossbeam to rise, and simultaneously the upper-layer crossbeam follows the lifting until the upper-layer crossbeam is locked to the upper-layer safety lock mechanism at the top of the single column, so as to complete parking of the first car;

before parking a second car, the hydraulic driving device drives the lower-layer crossbeam to descend to the lowest position, the cover plate changes to the second state, then the second car drives into the lower-layer car-carrying platform, the cover plate changes to the third state, the hydraulic driving device drives the lower-layer crossbeam to rise until the lower-layer crossbeam is locked to the lower-layer safety lock mechanism at the middle of the single column, so as to complete parking of the second car;

before parking a third car, the first car and the second car have been parked, and the third car drives in directly to complete parking of the third car.

Compared with the prior art, the four-post double-layer parking lift provided by the invention adopts the above structure design, where the upper-layer car-supporting plate and the lower-layer car-supporting plate share one ramp assembly, which not only reduces the manufacturing cost but also eliminates the step drop formed by stacking multi-layer ramps, thereby avoiding damage to the car chassis; meanwhile, through the outer sliding slots and inner sliding slots of the single columns and the hydraulic driving device, the lifting and lowering of the upper-layer car-supporting plate and the lower-layer car-supporting plate can be achieved, which not only simplifies the overall structure but also reduces the floor area space.

### BRIEF DESCRIPTION OF DRAWINGS

FIG. 1 is a first perspective structural schematic diagram of the invention;

FIG. 2 is a second perspective structural schematic diagram of the invention;

FIG. 3 is a perspective structural schematic diagram during a car drive-on process of the invention;

FIG. 4 is a perspective structural schematic diagram after parking three cars in the invention;

FIG. 5 is a perspective structural schematic diagram when the upper-layer crossbeam is located in the accommodating groove;

FIG. 6 is a perspective structural schematic diagram after the upper-layer crossbeam leaves the accommodating groove;

FIG. 7 is a perspective structural schematic diagram when the cover plate is in the first state;

FIG. 8 is a perspective structural schematic diagram when the cover plate is in the second state;

FIG. 9 is a perspective structural schematic diagram when the cover plate is in the third state;

FIG. 10 is an exploded view of the ramp assembly;

FIG. 11 is a front view of the ramp assembly;

FIG. 12 is an enlarged structural schematic diagram of part A in FIG. 11;

FIG. 13 is a perspective structural schematic diagram when the second ramp is flipped to the first ramp;

FIG. 14 is a perspective structural schematic diagram when the upper-layer crossbeam is in a locked state;

FIG. 15 is a perspective structural schematic diagram when the upper-layer crossbeam is in an unlocked state;

FIG. 16 is an exploded view of the upper-layer safety lock mechanism.

### REFERENCE NUMERALS

1. four-post bracket; 11. single column; 111. outer sliding slot; 112. inner sliding slot; 113. primary lock hole; 114. secondary lock seat;
2. upper-layer car-carrying platform; 20. upper-layer car-supporting plate; 21. upper-layer crossbeam; 211. primary lock seat; 212. secondary lock ear; 22. upper-layer safety lock mechanism; 221. primary safety lock component; 2211. primary cylinder; 2212. primary connecting block; 2213. primary stop block; 222. secondary safety lock component; 2221. secondary cylinder; 2222. secondary connecting block; 2223. secondary latch pin; 2224. secondary stop block; 23. transition plate;
3. lower-layer car-carrying platform; 30. lower-layer car-supporting plate; 31. lower-layer crossbeam; 32. lower-layer safety lock mechanism;
4. hydraulic driving device;
5. ramp assembly; 51. first ramp; 510. accommodating groove; 511. sliding through slot; 5111. first sliding segment; 5112. second sliding segment; 5113. third sliding segment; 5114. fourth sliding segment; 5115. first positioning point; 5116. second positioning point; 5117. third positioning point; 512. ramp inclined plate; 513. mounting flat plate; 514. ramp side plate; 52. sliding pin; 53. cover plate; 531. through hole; 532. shielding plate; 533. connection side plate; 534. handle; 54. second ramp; 55. connecting shaft.

### DETAILED DESCRIPTION OF THE EMBODIMENTS

The invention will be described in detail below in combination with specific embodiments.

In the invention, unless otherwise clearly specified and limited, when terms such as “disposed on”, “connected”, and “connection” appear, these terms should be understood in a broad sense, for example, it can be a fixed connection, a detachable connection, or an integral connection; it can be directly connected or connected through one or more intermediate media. For those skilled in the art, the specific meaning of the above terms in the invention can be understood according to specific circumstances. The directional words appearing in the invention are for better explaining the characteristics and the relationships between characteristics. It should be understood that when the placement direction of the invention changes, the characteristics and the directions of relationships between characteristics also change correspondingly. Therefore, the directional words do not constitute an absolute limiting effect on the characteristics and the relationships between characteristics in space, but only play a relative limiting effect.

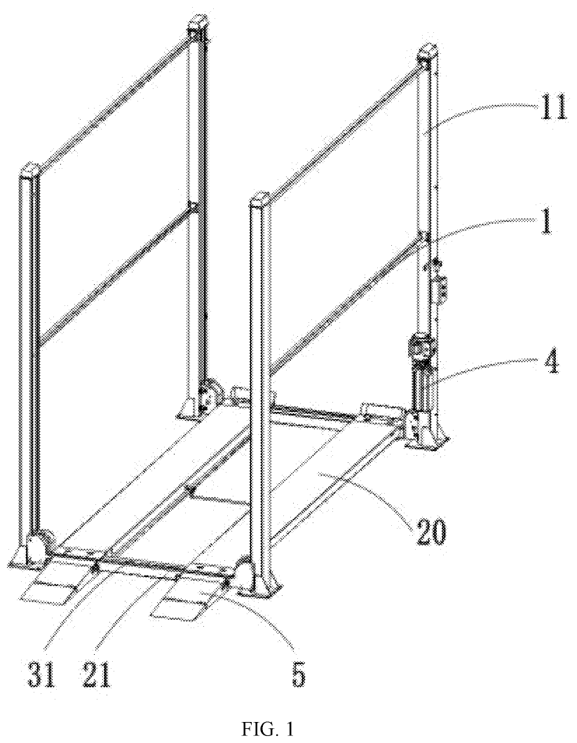

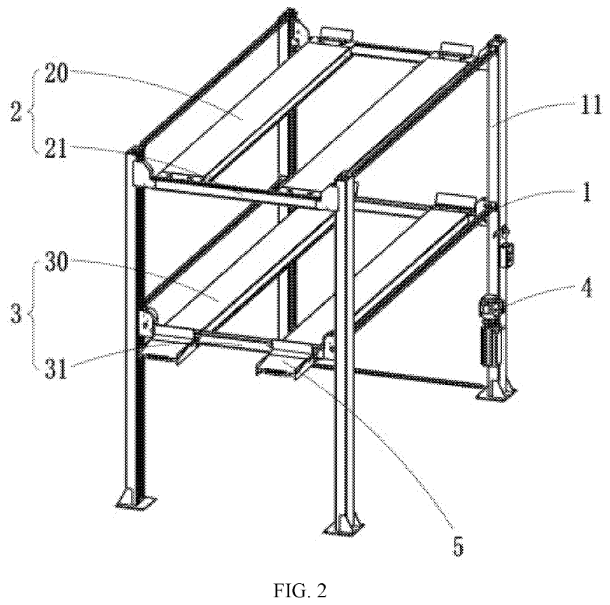

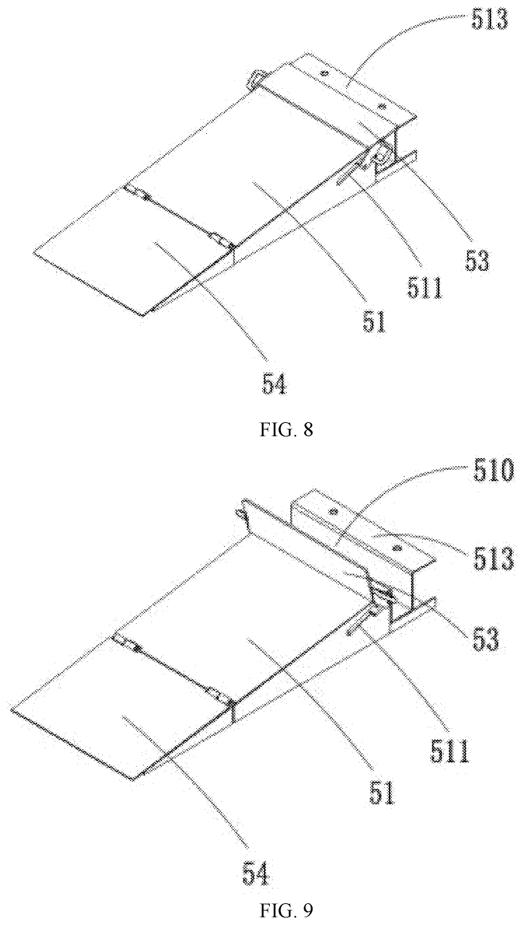

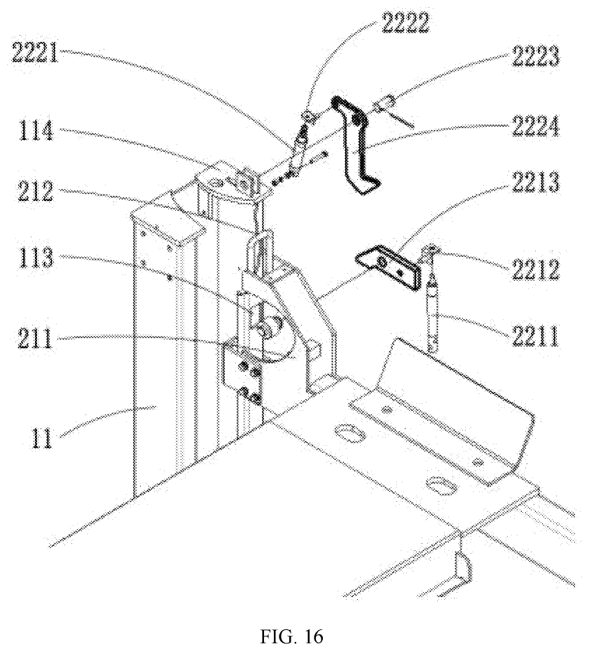

The invention provides a four-post double-layer parking lift, as shown in FIG. 1 to FIG. 16, which comprises a four-post bracket 1, an upper-layer car-carrying platform 2, a lower-layer car-carrying platform 3, and a hydraulic driving device 4. The four-post bracket 1 is provided with four single columns 11. Each single column 11 is provided with an outer sliding slot 111 and an inner sliding slot 112 that are parallel to each other. The lower-layer car-carrying platform 3 comprises two front and rear lower-layer crossbeams 31 and a lower-layer car-supporting plate 30 supported by the two lower-layer crossbeams 31. Two ends of each lower-layer crossbeam 31 are slidably connected to the inner sliding slots 112 and are driven by the hydraulic driving device 4 to lift and lower. The upper-layer car-carrying platform 2 comprises two front and rear upper-layer crossbeams 21 and an upper-layer car-supporting plate 20 supported by the two upper-layer crossbeams 21. Two ends of each upper-layer crossbeam 21 are slidably connected to the outer sliding slots 111. Through the outer sliding slots 111 and inner sliding slots 112 of the single columns 11 and the hydraulic driving device 4, the lifting and lowering of the upper-layer car-supporting plate 20 and the lower-layer car-supporting plate 30 can be achieved, which not only simplifies the overall structure but also reduces the floor area space.

A ramp assembly 5 is mounted on a front side of the lower-layer crossbeam 31. The ramp assembly 5 is provided with an accommodating groove 510. The upper-layer crossbeam 21 is configured to be embedded into the accommodating groove 510 from top to bottom. When the upper-layer crossbeam 21 is embedded in the accommodating groove 510, the upper-layer car-supporting plate 20 wraps the lower-layer car-supporting plate 30. Specifically, the cross sections of the upper-layer car-supporting plate 20 and the lower-layer car-supporting plate 30 are both in a channel steel shape, and the width of the upper-layer car-supporting plate 20 is greater than the width of the lower-layer car-supporting plate 30, so that the upper-layer car-supporting plate 20 can wrap the lower-layer car-supporting plate 30. Meanwhile, the processing of the upper-layer car-supporting plate 20 and the lower-layer car-supporting plate 30 in the channel steel shape is also more convenient and the cost is lower. When the lower-layer crossbeam 31 lifts or lowers, the ramp assembly 5 lifts or lowers synchronously and causes the upper-layer crossbeam 21 to follow the lifting or lowering by means of the ramp assembly 5.

An upper-layer safety lock mechanism 22 for locking the upper-layer crossbeam 21 at the top of the single column 11 is disposed between the single column 11 and the upper-layer crossbeam 21. A lower-layer safety lock mechanism 32 for locking the lower-layer crossbeam 31 at the middle of the single column 11 is disposed between the single column 11 and the lower-layer crossbeam 31. The lower-layer safety lock mechanism 32 is a secondary safety lock mechanism, which achieves instantaneous locking of a steel wire rope through two ways of mechanical insurance and circuit insurance, thereby achieving the locking of the lower-layer crossbeam 31. The lower-layer safety lock mechanism 32 is in the prior art, and its structure and working principle are not repeatedly described in this application.

Based on the above structural design, the upper-layer car-supporting plate 20 and the lower-layer car-supporting plate 30 share one ramp assembly 5, which not only reduces the manufacturing cost but also eliminates the step drop formed by stacking multi-layer ramps, thereby avoiding damage to the car chassis. No matter which layer the car drives onto, it is smooth and unobstructed.

In this embodiment, as shown in FIG. 7 to FIG. 9, the ramp assembly 5 comprises a first ramp 51, a sliding pin 52, and a cover plate 53. The accommodating groove 510 is disposed in the first ramp 51. A side surface of the first ramp 51 is provided with a sliding through slot 511. A side surface of the cover plate 53 is provided with a through hole 531. The sliding pin 52 passes through the sliding through slot 511 and the through hole 531. A placement mode of the cover plate 53 is changed by means of sliding the sliding pin 52 within the sliding through slot 511 so as to enable the cover plate 53 to be in a first state, a second state, and a third state; when the cover plate 53 is in the first state, the cover plate 53 leaves the accommodating groove 510 so that the upper part of the accommodating groove 510 is open, and the upper-layer crossbeam 21 is configured to be embedded into the accommodating groove 510 from top to bottom;

when the cover plate 53 is in the second state, the cover plate 53 is configured to cover the accommodating groove 510;

when the cover plate 53 is in the third state, the cover plate 53 is configured to be in a standing state.

Through the above structural design, when parking a first car, the cover plate 53 is in the first state, and the upper-layer car-supporting plate 20 and the lower-layer car-supporting plate 30 share one ramp assembly 5, thereby reducing the cost. When parking a second car, the cover plate 53 is in the second state, which can effectively avoid a situation where a wheel gets stuck, slips, or even overturns at the accommodating groove 510 when the second car drives into the lower-layer car-supporting plate 30, improving the stability of driving onto the platform. After the second car is parked or during the lifting and lowering process of the lower-layer crossbeam 31, the cover plate 53 is in the third state, which can play a role in stopping the wheel, reducing the risk of the car sliding or rolling, thereby protecting the safety of the car, passengers, and the surrounding environment.

In this embodiment, as shown in FIG. 7 to FIG. 11, the first ramp 51 comprises a ramp inclined plate 512 connected to the front of the accommodating groove 510, a mounting flat plate 513 connected to the rear of the accommodating groove 510, and ramp side plates 514 connected to two sides of the ramp inclined plate 512. The sliding through slot 511 is disposed in each ramp side plate 514. The mounting flat plate 513 is used for connection with the lower-layer crossbeam 31. The sliding through slot 511 comprises a first sliding segment 5111, a second sliding segment 5112, a third sliding segment 5113, and a fourth sliding segment 5114 which are communicated in sequence. A front end of the first sliding segment 5111 is a first positioning point 5115. A junction between the second sliding segment 5112 and the third sliding segment 5113 is a second positioning point 5116. A rear end of the fourth sliding segment 5114 is a third positioning point 5117. A connecting line between the first positioning point 5115 and the second positioning point 5116 is parallel to the ramp inclined plate 512. The cover plate 53 comprises a shielding plate 532 and connection side plates 533 connected to two sides of the shielding plate 532. The through hole 531 is disposed in each connection side plate 533.

In the first state, the sliding pin 52 slides to the first positioning point 5115, the bottom surface of the shielding plate 532 fits with the top surface of the ramp inclined plate 512, and the rear edge of the shielding plate 532 does not extend above the accommodating groove 510, ensuring that the shielding plate 532 does not block the accommodating groove 510, so that the upper-layer crossbeam 21 can be smoothly embedded into the accommodating groove 510.

In the second state, the sliding pin 52 slides to the second positioning point 5116, the front edge of the shielding plate 532 is overlapped on the ramp inclined plate 512, and the rear edge of the shielding plate 532 is overlapped on the mounting flat plate 513. Under the common support of the ramp inclined plate 512 and the mounting flat plate 513, the shielding plate 532 can be prevented from falling into the accommodating groove 510, improving the stability of driving onto the platform.

In the third state, the sliding pin 52 slides to the third positioning point 5117, the shielding plate 532 is placed in a posture with the front edge at a lower position and the rear edge at an upper position, the front edge of the shielding plate 532 is supported by the ramp inclined plate 512, and the overall center of gravity of the shielding plate 532 is further forward than the front edge, thereby ensuring that the sliding pin 52 will not be disengaged from the third positioning point 5117, playing a role in stopping the wheel.

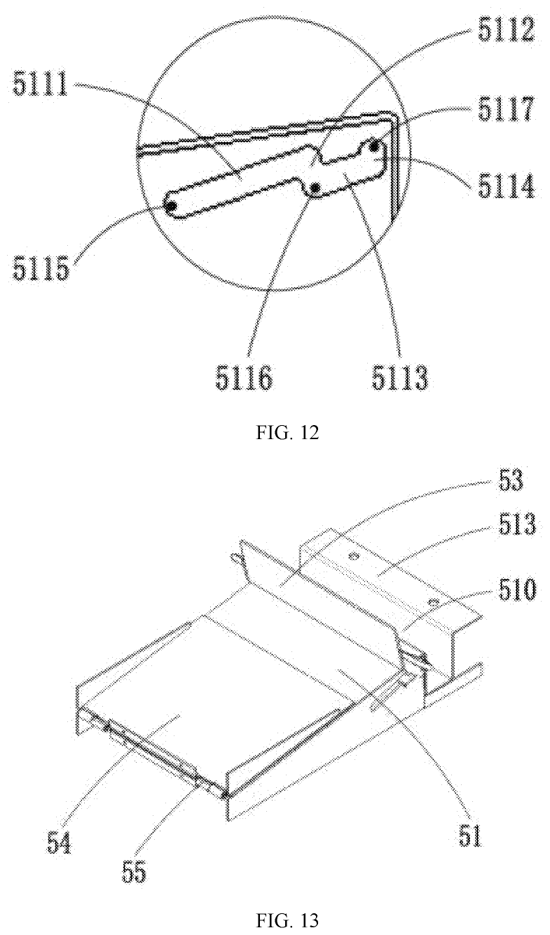

In this embodiment, as shown in FIG. 12, a Cartesian coordinate system is established with the first positioning point 5115 as the coordinate origin, the horizontal plane is in the X direction, and the vertical plane is in the Y direction. The direction of the first sliding segment 5111 extends along an inclined direction between the positive X-axis direction and the positive Y-axis direction. The direction of the second sliding segment 5112 extends along an inclined direction between the negative Y-axis direction and the positive X-axis direction. The direction of the third sliding segment 5113 extends along the inclined direction between the positive X-axis direction and the positive Y-axis direction. The direction of the fourth sliding segment 5114 extends upwardly along the positive Y-axis direction. Through the above multi-segment slot direction of the sliding through slot 511, three different placement modes of the cover plate 53 are realized to adapt to various usage requirements.

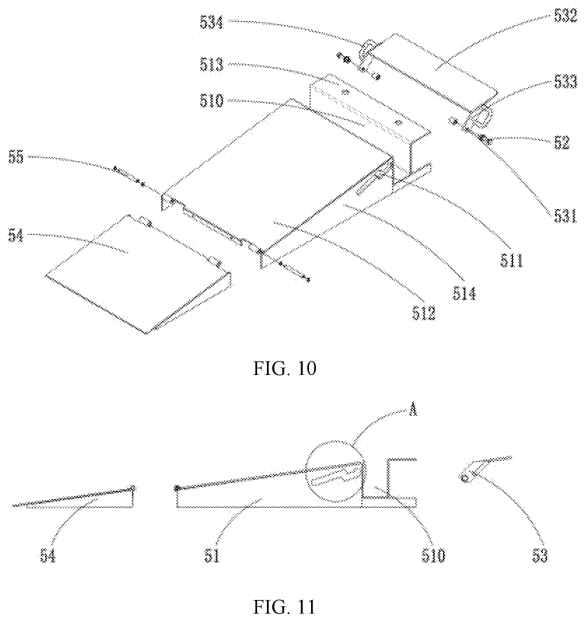

In this embodiment, as shown in FIG. 10, the connection side plate 533 is provided with a handle 534, which is convenient for an operator to adjust the placement mode of the cover plate 53 and reduces operational difficulty.

In this embodiment, as shown in FIG. 13, the ramp assembly 5 further comprises a second ramp 54. The second ramp 54 is hingedly connected to the first ramp 51 through a connecting shaft 55. The second ramp 54 is configured to rotate around the axis of the connecting shaft 55 so that the top surface of the second ramp 54 fits with the top surface of the first ramp 51. When a car is parked on the lower-layer car-supporting plate 30, the second ramp 54 can be manually flipped onto the first ramp 51, thereby reducing the suspended length of the ramp assembly 5 and avoiding space limitation caused by excessive length of the ramp assembly 5.

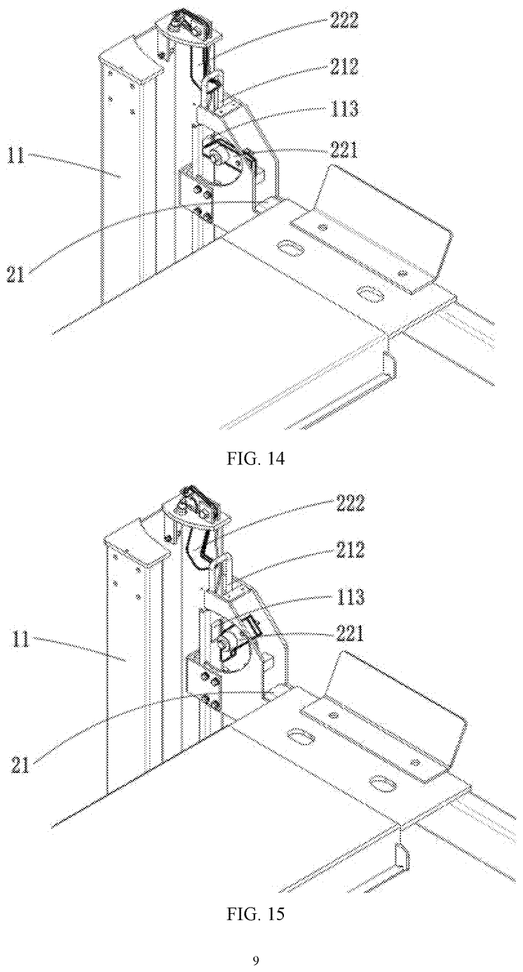

In this embodiment, as shown in FIG. 14 to FIG. 16, the upper-layer safety lock mechanism 22 comprises a primary safety lock component 221 and a secondary safety lock component 222. The primary safety lock component 221 is disposed on the upper-layer crossbeam 21. The secondary safety lock component 222 is disposed on the single column 11. The single column 11 is provided with a primary lock hole 113. The upper-layer crossbeam 21 is provided with a primary lock seat 211. The primary lock seat 211 is provided with a secondary lock ear 212.

When the primary safety lock component 221 is inserted into the primary lock hole 113 and the secondary safety lock component 222 hooks the secondary lock ear 212, the upper-layer car-carrying platform 2 is in a locked state.

When the primary safety lock component 221 is disengaged from the primary lock hole 113 and the secondary safety lock component 222 is disengaged from the secondary lock ear 212, the upper-layer car-carrying platform 2 is in an unlocked state.

Through the above structural design, the upper-layer safety lock mechanism 22 adopts a dual safety lock design. Even if the primary safety lock component 221 fails, the secondary safety lock component 222 can still play a role, ensuring the safety of the car and effectively preventing accidental unlocking or starting of the car caused by misoperation.

In this embodiment, as shown in FIG. 14 to FIG. 16, the primary safety lock component 221 comprises a primary cylinder 2211, a primary connecting block 2212, and a primary stop block 2213. A fixed end of the primary cylinder 2211 is hingedly connected to the primary lock seat 211. A portion of the primary stop block 2213 is hingedly connected to the primary lock seat 211. Another portion is hingedly connected to the telescopic end of the primary cylinder 2211 through the primary connecting block 2212. The primary stop block 2213 is configured to be driven by the primary cylinder 2211 to be inserted into or disengaged from the primary lock hole 113. The secondary safety lock component 222 comprises a secondary cylinder 2221, a secondary connecting block 2222, a secondary latch pin 2223, and a secondary stop block 2224. The single column 11 is provided with a secondary lock seat 114. A fixed end of the secondary cylinder 2221 is hingedly connected to the secondary lock seat 114. A portion of the secondary stop block 2224 is hingedly connected to the secondary lock seat 114 through the secondary latch pin 2223. Another portion is hingedly connected to the telescopic end of the secondary cylinder 2221 through the secondary connecting block 2222. The secondary stop block 2224 is configured to be driven by the secondary cylinder 2221 to hook or be disengaged from the secondary lock ear 212.

Through the above structural design, when unlocking is required, the primary cylinder 2211 drives the primary stop block 2213 to rotate, so that the primary stop block 2213 is disengaged from the primary lock hole 113, i.e., completing primary unlocking. The secondary cylinder 2221 drives the secondary stop block 2224 to rotate, so that the secondary stop block 2224 is disengaged from the secondary lock ear 212, i.e., completing secondary unlocking, thereby completely unlocking the upper-layer crossbeam 21.

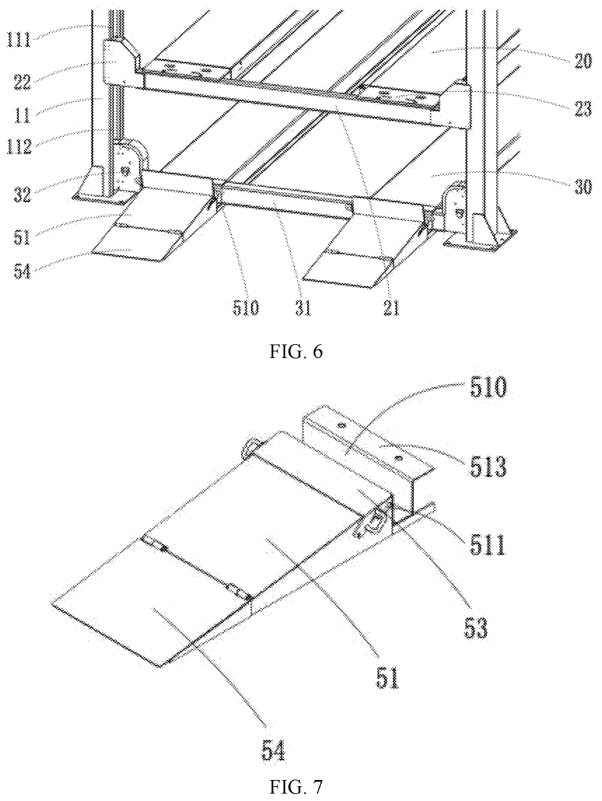

In this embodiment, as shown in FIG. 5 to FIG. 6, the upper-layer crossbeam 21 is provided with a transition plate 23. When the upper-layer crossbeam 21 is embedded in the accommodating groove 510, the transition plate 23 can cover the accommodating groove 510, which is convenient for a car to drive into the upper-layer car-supporting plate 20 and reduces the passing difficulty.

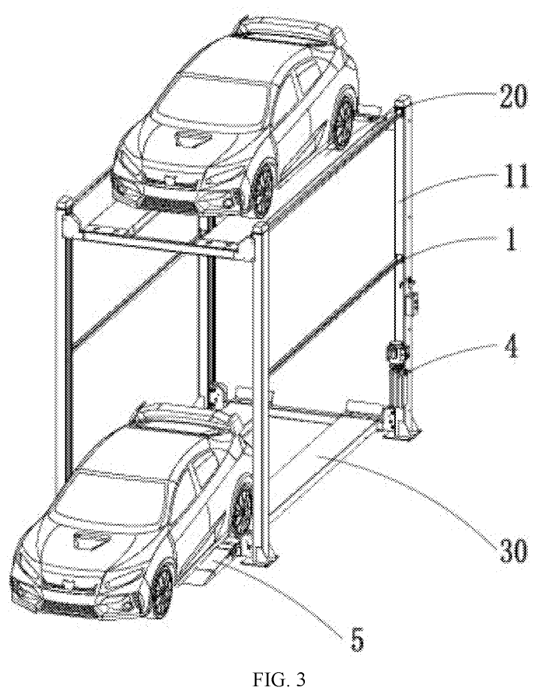

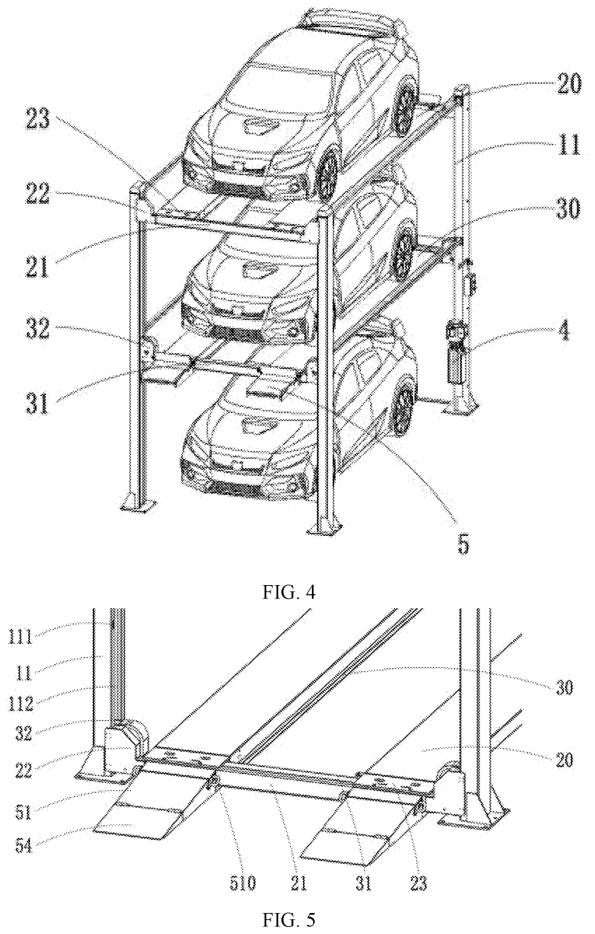

In this embodiment, as shown in FIG. 3 to FIG. 4, the four-post double-layer parking lift is configured to park three cars;

before parking a first car, the upper-layer crossbeam 21 and the lower-layer crossbeam 31 are at the lowest position. At this time the upper-layer crossbeam 21 is located in the accommodating groove 510, the cover plate 53 is in the first state, then the first car drives into the upper-layer car-carrying platform 2, the cover plate 53 changes to the third state, the hydraulic driving device 4 drives the lower-layer crossbeam 31 to rise, and simultaneously the upper-layer crossbeam 21 follows the lifting until the upper-layer crossbeam 21 is locked to the upper-layer safety lock mechanism 22 at the top of the single column 11, so as to complete parking of the first car;

before parking a second car, the hydraulic driving device 4 drives the lower-layer crossbeam 31 to descend to the lowest position, the cover plate 53 changes to the second state, then the second car drives into the lower-layer car-carrying platform 3, the cover plate 53 changes to the third state, the hydraulic driving device 4 drives the lower-layer crossbeam 31 to rise until the lower-layer crossbeam 31 is locked to the lower-layer safety lock mechanism 32 at the middle of the single column 11, so as to complete parking of the second car;

before parking a third car, the first car and the second car have been parked, and the third car drives in directly to complete parking of the third car.

In summary, this kind of four-post double-layer parking lift can solve the problems in the prior art where the upper-layer car-supporting plate and the lower-layer car-supporting plate of a double-layer lift respectively adopt independent ramps, column frames, and hydraulic driving systems, resulting in increased cost and complex structure.

Under a condition of no conflict, the above embodiments and characteristics in the embodiments can be combined with each other.

Finally, it should be noted that the above embodiments are only used to illustrate the technical solutions of the invention, rather than to limit the protection scope of the invention. Although the invention has been described in detail with reference to the preferred embodiments, those of ordinary skill in the art should understand that the technical solutions of the invention can be modified or equivalently replaced without departing from the essence and scope of the technical solutions of the invention.

1. A four-post double-layer parking lift, comprising a four-post bracket (1), an upper-layer car-carrying platform (2), a lower-layer car-carrying platform (3), and a hydraulic driving device (4), the four-post bracket (1) being provided with four single columns (11), each single column (11) being provided with an outer sliding slot (111) and an inner sliding slot (112) which are parallel to each other, the lower-layer car-carrying platform (3) comprising two front and rear lower-layer crossbeams (31) and a lower-layer car-supporting plate (30) supported by the two lower-layer crossbeams (31), two ends of each lower-layer crossbeam (31) being slidably connected to the inner sliding slots (112) and driven by the hydraulic driving device (4) to lift and lower, the upper-layer car-carrying platform (2) comprising two front and rear upper-layer crossbeams (21) and an upper-layer car-supporting plate (20) supported by the two upper-layer crossbeams (21), and two ends of each upper-layer crossbeam (21) being slidably connected to the outer sliding slots (111), characterized in that:
a ramp assembly (5) is mounted on a front side of the lower-layer crossbeam (31), the ramp assembly (5) is provided with an accommodating groove (510), the upper-layer crossbeam (21) is configured to be embedded into the accommodating groove (510) from top to bottom, when the upper-layer crossbeam (21) is embedded in the accommodating groove (510), the upper-layer car-supporting plate (20) wraps the lower-layer car-supporting plate (30) from top to bottom, and when the lower-layer crossbeam (31) lifts or lowers, the ramp assembly (5) lifts or lowers synchronously and causes the upper-layer crossbeam (21) to follow the lifting or lowering by means of the ramp assembly (5);
an upper-layer safety lock mechanism (22) for locking the upper-layer crossbeam (21) at a top of the single column (11) is disposed between the single column (11) and the upper-layer crossbeam (21), and a lower-layer safety lock mechanism (32) for locking the lower-layer crossbeam (31) at a middle of the single column (11) is disposed between the single column (11) and the lower-layer crossbeam (31);
the ramp assembly (5) comprises a first ramp (51), a sliding pin (52), and a cover plate (53), the accommodating groove (510) is disposed in the first ramp (51), a side surface of the first ramp (51) is provided with a sliding through slot (511), a side surface of the cover plate (53) is provided with a through hole (531), the sliding pin (52) passes through the sliding through slot (511) and the through hole (531), and a placement mode of the cover plate (53) is changed by means of sliding the sliding pin (52) within the sliding through slot (511) so as to enable the cover plate (53) to be in a first state, a second state, and a third state; the first ramp (51) comprises a ramp inclined plate (512) connected to a front of the accommodating groove (510), a mounting flat plate (513) connected to a rear of the accommodating groove (510), and ramp side plates (514) connected to two sides of the ramp inclined plate (512), the sliding through slot (511) is disposed in each ramp side plate (514), the mounting flat plate (513) is used for connection with the lower-layer crossbeam (31), the sliding through slot (511) comprises a first sliding segment (5111), a second sliding segment (5112), a third sliding segment (5113), and a fourth sliding segment (5114) which are communicated in sequence, a front end of the first sliding segment (5111) is a first positioning point (5115), a junction between the second sliding segment (5112) and the third sliding segment (5113) is a second positioning point (5116), a rear end of the fourth sliding segment (5114) is a third positioning point (5117), and a connecting line between the first positioning point (5115) and the second positioning point (5116) is parallel to the ramp inclined plate (512); the cover plate (53) comprises a shielding plate (532) and connection side plates (533) connected to two sides of the shielding plate (532), and the through hole (531) is disposed in each connection side plate (533);
when the cover plate (53) is in the first state, the cover plate (53) leaves the accommodating groove (510) so that an upper part of the accommodating groove (510) is open, and the upper-layer crossbeam (21) is configured to be embedded into the accommodating groove (510) from top to bottom;
when the cover plate (53) is in the second state, the cover plate (53) is configured to cover the accommodating groove (510);
when the cover plate (53) is in the third state, the cover plate (53) is configured to be in a standing state.

2. The four-post double-layer parking lift according to claim 1, characterized in that:
in the first state, the sliding pin (52) slides to the first positioning point (5115), a bottom surface of the shielding plate (532) fits with a top surface of the ramp inclined plate (512), and a rear edge of the shielding plate (532) does not extend above the accommodating groove (510);
in the second state, the sliding pin (52) slides to the second positioning point (5116), a front edge of the shielding plate (532) is overlapped on the ramp inclined plate (512), and the rear edge of the shielding plate (532) is overlapped on the mounting flat plate (513);
in the third state, the sliding pin (52) slides to the third positioning point (5117), the shielding plate (532) is placed in a posture with the front edge at a lower position and the rear edge at an upper position, the front edge of the shielding plate (532) is supported by the ramp inclined plate (512), and an overall center of gravity of the shielding plate (532) is further forward than the front edge.

3. The four-post double-layer parking lift according to claim 2, characterized in that: a Cartesian coordinate system is established with the first positioning point (5115) as a coordinate origin, a horizontal plane is in an X direction, and a vertical plane is in a Y direction, a direction of the first sliding segment (5111) extends along an inclined direction between a positive X-axis direction and a positive Y-axis direction, a direction of the second sliding segment (5112) extends along an inclined direction between a negative Y-axis direction and the positive X-axis direction, a direction of the third sliding segment (5113) extends along the inclined direction between the positive X-axis direction and the positive Y-axis direction, and a direction of the fourth sliding segment (5114) extends upwardly along the positive Y-axis direction.

4. The four-post double-layer parking lift according to claim 2, characterized in that: each connection side plate (533) is provided with a handle (534).

5. The four-post double-layer parking lift according to claim 1, characterized in that: the ramp assembly (5) further comprises a second ramp (54), the second ramp (54) is hingedly connected to the first ramp (51) through a connecting shaft (55), and the second ramp (54) is configured to rotate around an axis of the connecting shaft (55) so that a top surface of the second ramp (54) fits with a top surface of the first ramp (51).

6. The four-post double-layer parking lift according to claim 1, characterized in that: the upper-layer safety lock mechanism (22) comprises a primary safety lock component (221) and a secondary safety lock component (222), the primary safety lock component (221) is disposed on the upper-layer crossbeam (21), the secondary safety lock component (222) is disposed on the single column (11), the single column (11) is provided with a primary lock hole (113), the upper-layer crossbeam (21) is provided with a primary lock seat (211), and the primary lock seat (211) is provided with a secondary lock ear (212);
when the primary safety lock component (221) is inserted into the primary lock hole (113) and the secondary safety lock component (222) hooks the secondary lock ear (212), the upper-layer car-carrying platform (2) is in a locked state;
when the primary safety lock component (221) is disengaged from the primary lock hole (113) and the secondary safety lock component (222) is disengaged from the secondary lock ear (212), the upper-layer car-carrying platform (2) is in an unlocked state.

7. The four-post double-layer parking lift according to claim 6, characterized in that: the primary safety lock component (221) comprises a primary cylinder (2211), a primary connecting block (2212), and a primary stop block (2213), a fixed end of the primary cylinder (2211) is hingedly connected to the primary lock seat (211), a portion of the primary stop block (2213) is hingedly connected to the primary lock seat (211), another portion is hingedly connected to a telescopic end of the primary cylinder (2211) through the primary connecting block (2212), and the primary stop block (2213) is configured to be driven by the primary cylinder (2211) to be inserted into or disengaged from the primary lock hole (113);
the secondary safety lock component (222) comprises a secondary cylinder (2221), a secondary connecting block (2222), a secondary latch pin (2223), and a secondary stop block (2224), the single column (11) is provided with a secondary lock seat (114), a fixed end of the secondary cylinder (2221) is hingedly connected to the secondary lock seat

(114) a portion of the secondary stop block (2224) is hingedly connected to the secondary lock seat (114) through the secondary latch pin (2223), another portion is hingedly connected to a telescopic end of the secondary cylinder (2221) through the secondary connecting block (2222), and the secondary stop block (2224) is configured to be driven by the secondary cylinder (2221) to hook or be disengaged from the secondary lock ear (212).

8. The four-post double-layer parking lift according to claim 1, characterized in that: the upper-layer crossbeam (21) is provided with a transition plate (23), and when the upper-layer crossbeam (21) is embedded in the accommodating groove (510), the transition plate (23) is configured to cover the accommodating groove (510).

9. The four-post double-layer parking lift according to claim 1, characterized in that: the four-post double-layer parking lift is configured to park three cars;
before parking a first car, the upper-layer crossbeam (21) and the lower-layer crossbeam (31) are at a lowest position, at this time the upper-layer crossbeam (21) is located in the accommodating groove (510), the cover plate (53) is in the first state, then the first car drives into the upper-layer car-carrying platform (2), the cover plate (53) changes to the third state, the hydraulic driving device (4) drives the lower-layer crossbeam (31) to rise, and simultaneously the upper-layer crossbeam (21) follows the lifting until the upper-layer crossbeam (21) is locked to the upper-layer safety lock mechanism (22) at the top of the single column (11), so as to complete parking of the first car;
before parking a second car, the hydraulic driving device (4) drives the lower-layer crossbeam (31) to descend to the lowest position, the cover plate (53) changes to the second state, then the second car drives into the lower-layer car-carrying platform (3), the cover plate (53) changes to the third state, the hydraulic driving device (4) drives the lower-layer crossbeam (31) to rise until the lower-layer crossbeam (31) is locked to the lower-layer safety lock mechanism (32) at the middle of the single column (11), so as to complete parking of the second car;
before parking a third car, the first car and the second car have been parked, and the third car drives in directly to complete parking of the third car.
